(19) United States
(12) Patent Application Publication
(10) Pub. No.: US 2009/0191390 A1
(43) Pub. Date: Jul. 30, 2009

(54) PAINT ROLLER HAVING REINFORCEMENT LAYERS AND METHOD FOR ASSEMBLING THE PAINT ROLLER

(75) Inventors: Makoto Saji, West Hills, CA (US); Brent Swenson, Brea, CA (US)

Correspondence Address: RATNERPRESTIA, P.O. BOX 980, VALLEY FORGE, PA, 19482, US

(73) Assignee: Linzer Products Corp., Wyandanch, NY (US)

(21) Appl. No.: 12/019,749

(22) Filed: Jan. 25, 2008

(51) Int. Cl. B32B 7/12; B32B 7/02; B29C 63/10; B65H 81/06

(52) U.S. Cl. 428/213; 428/222; 156/188; 428/218; 242/430

(57) ABSTRACT

A paint roller assembly and method of assembling the paint roller assembly is disclosed. The paint roller assembly comprises a core layer, a first reinforcement layer, a second reinforcement layer, a fabric cover, and adhesive for joining the layers and fabric cover together. The method of assembling the paint roller assembly includes the steps of helically winding a core material around a mandrel, applying adhesive to an exposed portion of the core material, helically winding a first reinforcement layer around the core material, applying the adhesive to an exposed portion of the first reinforcement layer, helically winding a second reinforcement layer around the first reinforcement layer, applying the adhesive to an exposed portion of the second reinforcement layer, and helically winding a fabric cover over the second reinforcement layer.

### FIELD OF THE INVENTION

The present invention relates generally to paint rollers and methods of assembling the same, and more specifically to a paint roller including multiple reinforcement layers.

### BACKGROUND

Paint rollers are employed to paint a variety of surfaces, such as walls and ceilings. Paint rollers are typically comprised of at least a core layer and a paint absorbing cover. The core layer may be a solid structure, or helically wound strip or strips of material which are bonded together to form a tubular structure The paint absorbing cover may be composed of a woven synthetic or natural fabric, or other materials that are well known in the art. Improvements are continually sought to maximize the integrity, durability, strength and manufacturability of paint rollers.

### SUMMARY OF THE INVENTION

The paint roller described hereinafter includes multiple reinforcement layers. Among other benefits, the subject paint roller exhibits many desirable properties including hardened feel, low weight, improved crush resistance, and reduced susceptibility to unfurling.

According to one aspect of the invention, a paint roller assembly is disclosed. The paint roller assembly comprises a core layer, a first reinforcement layer helically wound over the core layer, a second reinforcement layer helically wound over the first reinforcement layer, and a fabric cover helically wound over the second reinforcement layer. An adhesive is optionally provided for joining the core layer, the first reinforcement layer, the second reinforcement layer and the fabric cover together.

According to another aspect of the invention, a method of assembling a paint roller is disclosed. The method comprises the step of helically winding a core material around a mandrel. Adhesive is applied to an exposed portion of the core material. A first reinforcement layer is helically wound around the core material. Adhesive is applied to an exposed portion of the first reinforcement layer. A second reinforcement layer is helically wound around the first reinforcement layer. Adhesive is applied to an exposed portion of the second reinforcement layer. A fabric cover is helically wound around the second reinforcement layer.

According to yet another aspect of the invention, an apparatus for forming a paint roller is disclosed. The apparatus comprises a mandrel having a longitudinal axis. A first feeder is provided for continuously winding a core material around the longitudinal axis of the mandrel. A second feeder is provided for continuously winding a first reinforcing material around the core material. A third feeder is provided for continuously winding a second reinforcing material around the first reinforcing material. A fourth feeder is provided for continuously winding a fabric cover around the second reinforcement layer. A driving apparatus is optionally provided for advancing the core material, reinforcement layers and fabric cover along the mandrel.

According to still another aspect of the invention, the paint roller assembly comprises a core layer, a plurality of reinforcement layers helically wound over the core layer, and a fabric cover helically wound over the plurality of reinforcement layers.

### BRIEF DESCRIPTION OF THE DRAWINGS

The invention is best understood from the following detailed description when read in connection with the accompanying drawings. It is emphasized that, according to common practice, the various features of the drawing are not to scale. On the contrary, the dimensions of the various features are arbitrarily expanded or reduced for clarity. Included in the drawing are the following figures:

FIG. 1 depicts a perspective view of a paint roller device in accordance with the invention, with a section truncated for clarity;

FIG. 2 depicts a cross-sectional view of the paint roller device of FIG. 1 taken through line 2-2 of FIG. 1;

FIG. 3 depicts a schematic view of an apparatus for assembling the paint roller of FIG. 1; and

FIG. 4 depicts a schematic view of the apparatus of FIG. 3, whereby another method of assembling the paint roller of FIG. 1 is illustrated.

### DETAILED DESCRIPTION

Although the invention is illustrated and described herein with reference to specific embodiments, the invention is not intended to be limited to the details shown. Rather, various modifications may be made in the details within the scope and range of equivalents of the claims and without departing from the invention.

Referring generally to the figures, and according to one aspect of the invention, a paint roller assembly 10 is disclosed. The paint roller assembly 10 comprises a core layer 12, a first reinforcement layer 14 helically wound over the core layer 12, a second reinforcement layer 16 helically wound over the first reinforcement layer 14, and a fabric cover 18 helically wound over the second reinforcement layer 16. An adhesive 28 is optionally provided for joining the core layer 12, the first reinforcement layer 14, the second reinforcement layer 16, and the fabric cover 18 together.

According to another aspect of the invention, a method of assembling a paint roller 10 is disclosed. The method comprises the step of helically winding a core material 12 around a mandrel 22. Adhesive 28 is applied to an exposed portion of the core material 12. A first reinforcement layer 14 is helically wound around the core material 12. Adhesive 28 is applied to an exposed portion of the first reinforcement layer 14. A second reinforcement layer 16 is helically wound around the first reinforcement layer 14. Adhesive 28 is applied to an exposed portion of the second reinforcement layer 16. A fabric cover 18 is helically wound around the second reinforcement layer 16.

According to yet another aspect of the invention, an apparatus 20 for forming a paint roller 10 is disclosed. The apparatus 20 comprises a mandrel 22 having a longitudinal axis. A first feeder 40 is provided for continuously winding a core material 12 around the longitudinal axis of the mandrel 22. A second feeder 42 is provided for continuously winding a first reinforcing material 14 around the core material 12. A third feeder 44 is provided for continuously winding a second reinforcing material 16 around the first reinforcing material 14. A fourth feeder 46 is provided for continuously winding a fabric cover 18 around the second reinforcement layer 16. A driving apparatus 32 is optionally provided for advancing the core material 12, reinforcement layers 14 and 16 and fabric cover 18 along the longitudinal axis of the mandrel 22.

According to still another aspect of the invention, the paint roller assembly 10 comprises a core layer 12, a plurality of reinforcement layers 14 and 16 helically wound over the core layer 12, and a fabric cover 18 helically wound over the plurality of reinforcement layers 14 and 16.

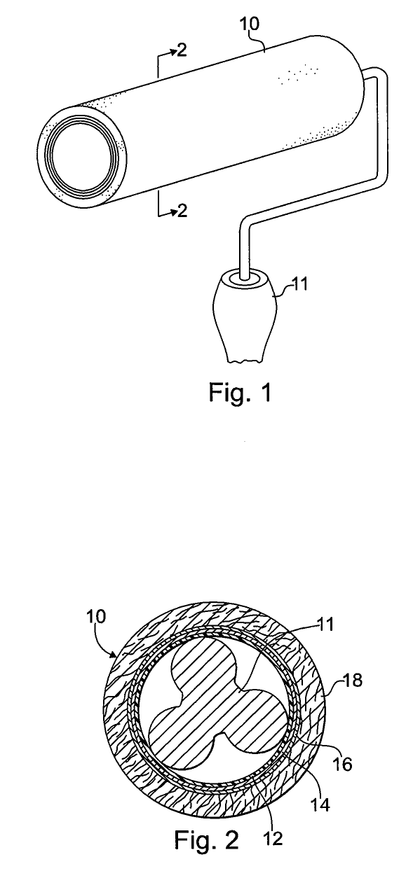

FIG. 1 depicts a perspective view of a paint roller device in accordance with one exemplary embodiment of the invention. The paint roller device includes a paint roller 10 attached to a paint roller handle assembly 11. Paint rollers like paint roller 10 may also be referred to as paint roller assemblies, paint roller covers or paint roller cover assemblies.

Referring now to FIG. 2, paint roller 10 generally includes a core layer or core material 12, a first reinforcement layer 14 positioned over core layer 12, a second reinforcement layer 16 positioned over the first reinforcement layer 14, and a fabric layer 18 positioned over the second reinforcement layer 16.

By way of non-limiting example, the core layer 12 is comprised of a single inner layer, or ply, of helically wound material. The helically wound core layer 12 is optionally composed of polypropylene, or another thermoplastic material, for example. The core layer 12 material may be provided in roll form to facilitate the assembly process of paint roller 10.

In assembled form, the core layer 12 includes a hollow interior having a diameter suitable to accommodate the paint roller handle assembly 11, as shown in FIG. 1. The interior diameter of core layer 12 may be about 1½ inches or about ½ inch, which are industry standard dimensions. Alternatively, the interior diameter of core layer 12 may be maintained at any other desired dimension.

Two discrete reinforcement layers 14 and 16 are sequentially helically wound about the core layer 12. The first reinforcement layer 14 may be bonded to the core layer 12 by liquid polypropylene or any other suitable adhesive, for example. Similarly, the second reinforcement layer 16 may be bonded to the first reinforcement layer 14 by liquid polypropylene or any other suitable adhesive, for example.

As compared with conventional paint rollers comprising a single reinforcement layer, the potential for bending and buckling of a paint roller having a supplementary reinforcement layer 16 is substantially reduced. Moreover, reinforcement layers 14 and 16 provide improved structural integrity and hoop strength needed to withstand internal stresses exerted by the core layer 12 (which has a propensity to unfurl) and external forces in use. Additionally, two reinforcement layers are better able to retain the shape of a paint roller 10 than a single reinforcement layer. The benefits of paint rollers including an additional reinforcement layer are particularly pronounced for industry standard paint rollers having a large length, such as 18 inches, which have an increased propensity to unfurling, bending and buckling. The additional reinforcement layer 16 is comparatively lightweight, while consequently increasing the structural integrity and hoop strength of the paint roller.

A paint roller comprising supplementary reinforcement layers is better able to prevent deterioration of the core layer resulting from contact with harsh chemicals and solvents, such as paint thinners. For example, the supplementary reinforcement layer 16 provides another barrier for harsh chemicals and solvents to traverse before reaching the core layer 12.

As described above, the helically wound core layer 12 has the propensity to unfurl. The supplementary reinforcement layer improves the resistance of the helically wound core layer 12 to unfurling, snapping or splitting, by virtue of the improved bonding characteristics of paint roller 10. As described in greater detail later, the first reinforcement layer 14 is bonded to the core layer 12 and the second reinforcement layer 16 is bonded to the fabric cover 18. Bonding core layer 12 to a first reinforcement layer 14 and bonding fabric cover 18 to a second reinforcement layer 16 greatly reduces the potential for snapping or splitting of the core layer 12 and helps the core layer retain its original shape.

While two reinforcement layers 14 and 16 are shown in FIGS. 2 and described herein, it should be understood that the invention is not limited to two reinforcement layers. The paint roller 10 may include three or more reinforcement layers without departing from the scope of the invention. In view of the foregoing, it may be broadly stated that the paint roller includes multiple reinforcement layers, or that the paint roller includes a plurality of reinforcement layers.

The reinforcement layers 14 and 16 may be formed from a variety of materials, as described hereinafter. The reinforcement layers 14 and 16 made be formed from a thin, light-weight, non-thermoplastic material having a high tensile strength. The material of the reinforcement layers 14 and 16 may include an open weave structure including relatively large openings. In this arrangement, the openings offer a reduction in weight and also permit adhesive to pass through the cross-section of the paint roller 10, for bonding all of the layers of the paint roller together.

As one example, the reinforcement layers 14 and 16 may be formed from a non-thermoplastic mesh material, such as a mesh material manufactured by New York Wire Company, 152 North Main Street, Mount Wolf, Pa., USA, for example. The mesh may include a variety of materials including, but not limited to, woven or non-woven fabrics, porous or nonporous, tapes, screens, sheaths, wires, solid or perforated sheets, grids, nets, powders, lattice structures and other materials.

As another example, the reinforcement layers 14 and 16 may be formed from fiberglass mesh or fine metal wire (such as screen material). As yet another example, the reinforcement layers 14 and 16 may be formed from other synthetic or natural materials, including but not limited to the following: rayon, nylon, polyethylene, polyacylonitrile, sisal, cellulose, hemp, and any combination thereof. According to still another example, the reinforcement layers 14 and 16 may be formed from a solid strip of paperboard or metal reinforcement layer to yield a sufficiently strong and lightweight paint roller 10. The material of the reinforcement layers 14 and 16 may also be resistant to solvents or other chemicals.

The nominal thickness of each reinforcement layer 14 and 16 may be minimized in an effort to minimize the weight and bulk of paint roller 10 while maintaining the structural integrity of the paint roller 10. The thickness of reinforcement layer 14 and/or 16 may vary, depending upon the amount of rigidity of the paint roller desired by the end user. The thickness of the reinforcement layers is generally proportional to the structural rigidity of the paint roller 10. The nominal thickness of each reinforcement layer 14 or 16 may be less than about 0.5 millimeters, for example, while still possessing superior structural integrity. Additionally, the density and mesh size of the reinforcement layer 14 and/or 16 may vary for achieving a desired weight and/or tensile strength of the paint roller 10. Where the mesh material comprises a screen, the screen may be formed of strands made of an impermeable material. The density (i.e. spacing) of the strands may be varied among the reinforcement layers to control the rate of percolation of liquids from cover 18 through the mesh layers.

The tensile strength of the material comprising the reinforcement layers 14 and 16 may be sufficiently great to overcome expansion forces and stresses exerted by the underlying core layer 12, such as the expansion forces created by the tendency of the helically wound core layer 12 to unwind. In addition, the material comprising the reinforcement layers 14 and 16 preferably has sufficient rigidity to retain its cylindrical shape around the core layer 12 and to resist bending or buckling when the core layer 12 is subjected to external compressive forces in use.

In an effort to minimize the use of spray adhesives or ease the assembly process of paint roller 10, the reinforcement layers 14 and 16 may be adhesive-backed. The adhesive-backed reinforcement layers 14 and 16 may be fed from a roll and helically wound over the exterior exposed surface of core layer 12 to secure the turns of the paint roller 10 together.

According to one aspect of the invention, reinforcement layers 14 and 16 may be formed from different materials. Reinforcement layer 14 may be formed of a first material specifically compatible with the material of core layer 12, and reinforcement layer 16 may be formed of a second material specifically compatible with fabric cover 18. By way of non-limiting example, the first reinforcement layer 14 may be formed from fiberglass mesh, and the second reinforcement layer 16 may be formed from nylon, for example. Utilizing different materials for the reinforcement layers 14 and 16 may result in a lower susceptibility to unfurling of paint roller assembly 10. According to another aspect of the invention, reinforcement layer 14 may be adhesive backed, while reinforcement layer 16 is not adhesive-backed, or vice versa.

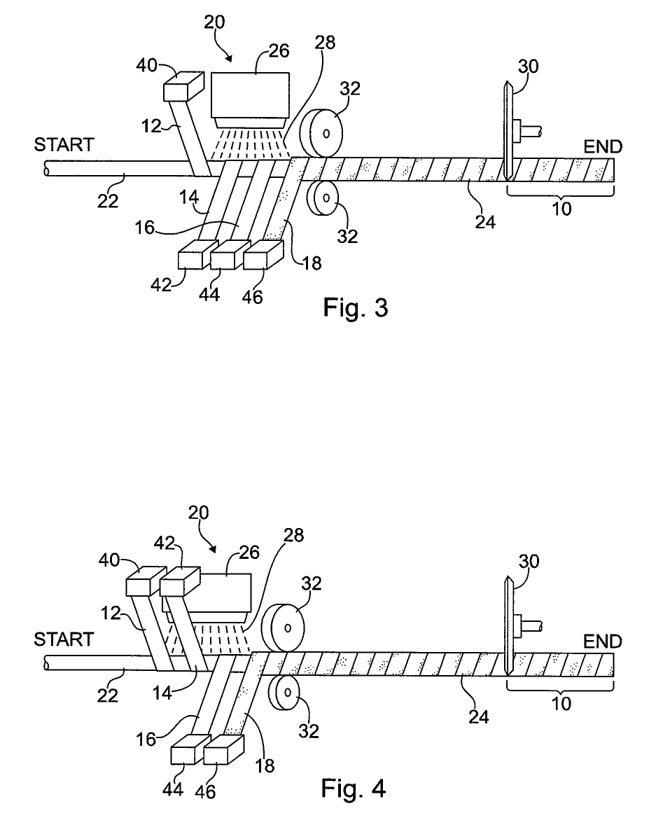

Regardless of the material type, the reinforcement layers 14 and 16 material may be provided in roll form to facilitate the assembly process of paint roller 10, as described in greater detail with reference to FIGS. 2 and 3.

A fabric layer or fabric cover 18 is helically wound about and secured to the second reinforcement layer 16. The fabric layer 18 may be formed from any suitable material, and is preferably a fabric suitable for painting, such as pile or nap with an open weave backing. The fabric layer 18 may be composed of a suitable thermoplastic material such as polyester woven into the fabric The fabric pile or nap may be composed of various materials or material blends, and be of different heights depending upon the particular application. Moreover, the fabric pile may be composed of materials suitable for the application of paint, stain, varnish or other types of surface coatings.

Those skilled in the art will recognize that the fabric cover 18 is not limited to being helically wound about the second reinforcement layer 16, and may be positioned over the second reinforcement layer in a variety of fashions. The fabric layer 18 may be secured to the second reinforcement layer 16 by liquid polypropylene or any other suitable adhesive, for example. Alternatively, the fabric layer 18 may be adhesive-backed. The fabric layer 18 material may optionally be provided in roll form to facilitate the assembly process of paint roller 10, as described in greater detail with reference to FIGS. 3 and 4.

FIG. 3 depicts a schematic view of an apparatus 20 for assembling the paint roller 10 of FIG. 1. In FIG. 3, the paint roller manufacturing apparatus 20 includes a stationary mandrel 22 upon which the paint roller 10 is assembled. The diameter of the mandrel 22 may be maintained at either about 1½ inches or about ½ inch to yield paint rollers having the same interior diameter. Other diameters may be selected for the mandrel 22 to accommodate other paint roller sizes. The mandrel 22 may also be tapered to facilitate removal of the paint rollers.

Paint roller manufacturing apparatus 20 includes a unique arrangement of feeder mechanisms and other components that produce paint roller 10. For purposes of description, the relative position of components of the apparatus 20 may be described as being “downstream” or “upstream” from one another. “Downstream” generally refers to a direction toward the end of the assembly line (labeled ‘END’), and “upstream” generally refers to the direction toward the beginning of the assembly line (labeled ‘START’).

The paint roller manufacturing apparatus 20 includes one or more feeders 40, 42, 44 and 46 for adding each of the component parts to form an endless paint roller 24. The feeder mechanisms may be in the form of spindles, spools or other application means that allow for the materials, which typically are supplied in rolls, to be applied in a continuous fashion. A first feeder 40 continuously feeds the core layer 12, a second feeder 42 continuously feeds first reinforcement layer 14, a third feeder 44 continuously feeds second reinforcement layer 16, and a fourth feeder 46 continuously feeds fabric layer 18. As an alternative to continuous feeders, any of the paint roller materials may be applied to a mandrel manually. The widths of the individual strips of material may be substantially equal, as shown, or may vary from that shown.

The paint roller manufacturing apparatus 20 optionally includes an adhesive applicator 26 for distributing adhesive material 28 onto several layers of the paint roller 10. The adhesive applicator 26 may be in the form of a single head, as shown, or multiple heads, if so desired. According to one exemplary embodiment, the adhesive applicator 26 distributes adhesive material 28, such as liquid polypropylene, onto the exposed surfaces of the layers 12, 14 and 16. Alternatively, if the layers 14, 16 and 18 are adhesive backed, the adhesive applicator 26 may be omitted. The width and position of the adhesive applicator 26 is positioned to distribute adhesive onto the exposed portions of the core layer 12, the first reinforcement layer 14, and the second reinforcement layer 16. The adhesive applicator 26 is preferably positioned so as to avoid dispensing adhesive onto the exposed surface of the fabric layer 18. As an alternative to adhesive bonding, the layers 12, 14, 16 and 18 may be bonded by applying heat to the endless paint roller 24.

According to one exemplary use of apparatus 20, the core layer 12 is wound about the exposed surface of the mandrel 22 from first feeder 40, which may be a spool, roll, or other means of dispensing core material. The adhesive applicator 26 applies adhesive to the exposed surface of the core layer 12. The first reinforcement layer 14 is then wound about the adhesive soaked surface of the core layer 12 from the second feeder 42. The adhesive applicator 26 simultaneously applies adhesive to the exposed surface of the first reinforcement layer 14 as the first reinforcement layer is wound onto the mandrel, or just after it is wound onto the mandrel. The second reinforcement layer 16 is then wound about the adhesive soaked surface of the first reinforcement layer 14 from a third feeder 44. The adhesive applicator 26 simultaneously applies adhesive to the exposed surface of the second reinforcement layer 16. The fabric layer 18 is then wound about the adhesive soaked surface of the second reinforcement layer 16 from fourth feeder 46.

A cutting device 30 is utilized to cut the endless paint roller 24 into separate paint rollers 10. The separate paint rollers 10 may then be packaged, or processed in subsequent steps. Although not shown, the manufacturing apparatus 20 includes a driving apparatus 32, which advances the endless paint roller along the mandrel 22. The driving apparatus 32 may be provided in the form of a gear or a belt. The driving apparatus 32 is preferably placed at a location downstream of the location where the fabric layer 18 is wound onto the second reinforcement layer 16. In this arrangement, the driving apparatus 32 is provided with sufficient traction to advance the core layer 12, reinforcement layers 14 and 16, and the fabric layer 18 along the longitudinal axis of the mandrel 22. In addition, the downstream position of the driving apparatus 32 permits it to simultaneously compress all of the paint roller layers together.

The axial position and angular orientation of layers 12, 14, 16 and 18 relative to the longitudinal axis of paint roller 10 influence the structural integrity of the paint roller. Because the materials are wound onto the mandrel in strip form, the successive winds or “turns” create helical seams in between each of the turns. In not properly reinforced, these seams can form weak areas that allow the roller 10 to unfurl or change shape. According to one aspect of the invention, the edges of one or more layers 14, 16 and 18 may be axially offset from the seams in layer 12 and/or the seams in any of the remaining layers so that the seam along one layer is not radially aligned with seams of an adjacent layer. For example, the edges of the first reinforcement layer 14 may be axially offset with respect to the edges of the second reinforcement layer 16. In this arrangement, the seam running through the second reinforcement layer 16 is not aligned over top the seam running through the first reinforcement layer 14. In this arrangement, the seams of adjacent layers are staggered along the length of the roller so that any potential weak areas are not concentrated together.

Additionally, the layers 12, 14, 16 and 18 may be wound in an angularly offset or transverse orientation relative to the each other, forming a criss-cross overlap. For example, as depicted in FIG. 3, the core layer 12 is angularly offset with respect to layers 14, 16 and 18. The orientation of the layers 12, 14, 16 and 18 may vary from that shown in FIG. 3. For example, the fabric layer 18 may be wound onto the mandrel 22 at an angle parallel to the angle of core layer 12, and be angularly offset with respect to the second reinforcement layer 16. The first reinforcement layer 14 may be angularly offset with respect to the second reinforcement layer 16 in a similar manner. Furthermore, the first reinforcement layer 14 may be angularly offset and axially offset with respect to the second reinforcement layer 16 to maximize structural integrity of the paint roller 10.

FIG. 4 depicts a schematic view of the paint roller manufacturing apparatus 20 of FIG. 3, whereby the paint roller 10 of FIG. 1 is being formed by another process. In FIG. 4, the first reinforcement layer 14 is wound in an angularly offset or transverse orientation relative to the second reinforcement layer 16. Winding the first reinforcement layer 14 in an angularly offset or transverse orientation relative to the second reinforcement layer 16 increases the structural integrity of the paint roller 10. In particular, the second reinforcement layer 16 crosses the seam formed between the turns of the first reinforcement layer 14 to prevent against longitudinal separation or shifting of the first reinforcement layer.

Although illustrated and described above with reference to certain specific embodiments, the present invention is nevertheless not intended to be limited to the details shown. Rather, various modifications may be made in the details within the scope and range of equivalents of the claims and without departing from the spirit of the invention. For example, although the term “paint roller” has been used in this specification, the products and processes within the scope of the invention are not limited to paint applications, and may be employed for any application for applying liquid to any surface.

What is claimed:

1. A paint roller assembly comprising:
a core layer;
a first reinforcement layer helically wound over the core layer;
a second reinforcement layer helically wound over the first reinforcement layer;
a fabric cover helically wound over the second reinforcement layer; and
adhesive for joining the core layer, the first reinforcement layer, the second reinforcement layer, and the fabric cover together.

2. The paint roller assembly of claim 1, wherein the first reinforcement layer and the second reinforcement layer are composed of different materials.

3. The paint roller assembly of claim 1, wherein the first reinforcement layer and/or the second reinforcement layer are formed from a mesh material having an open weave structure including openings.

4. The paint roller assembly of claim 4, wherein the mesh material is a non-thermoplastic material.

5. The paint roller assembly of claim 1, wherein the non-thermoplastic material is a fiberglass mesh material.

6. The paint roller assembly of claim 1, wherein the second reinforcement layer covers the first reinforcement layer in a criss-cross overlap.

7. The paint roller assembly of claim 1, wherein the fabric cover covers the second reinforcement layer in a criss-cross overlap.

8. The paint roller assembly of claim 1, wherein an edge of the second reinforcement layer is positioned over the first reinforcement layer at a location that is axially offset from a helically wound edge of the first reinforcement layer.

9. The paint roller assembly of claim 1, wherein an edge of the fabric cover is positioned over the second reinforcement layer at a location that is axially offset from a helically wound edge of the second reinforcement layer.

10. A method of assembling a paint roller comprising the steps of:
helically winding a core material around a mandrel;
applying an adhesive to an exposed portion of the core material;
helically winding a first reinforcement layer around the core material;
applying the adhesive to an exposed portion of the first reinforcement layer;
helically winding a second reinforcement layer around the first reinforcement layer;
applying the adhesive to an exposed portion of the second reinforcement layer; and
helically winding a fabric cover over the second reinforcement layer.

11. The method of claim 10, comprising the step of applying a compressive force upon the fabric cover after the step of helically winding the fabric cover over the second reinforcement layer.

12. The method of claim 10, wherein the steps of applying the adhesive are performed simultaneously from a single stream of adhesive material.

13. The method of claim 10, wherein the step of helically winding the second reinforcement layer comprises the step of positioning an edge of the second reinforcement layer over the first reinforcement layer at a location that is axially offset from a helically wound edge of the first reinforcement layer.

14. The method of claim 10, wherein the step of helically winding the second reinforcement layer comprises the step of winding the second reinforcement layer over the helically wound first reinforcement layer in a criss-cross overlap.

15. The method of claim 10, wherein the step of helically winding the second reinforcement layer comprises the step of winding the second reinforcement layer in the same direction that the first reinforcement layer is wound.

16. The method of claim 10, wherein the step of helically winding the second reinforcement layer comprises the step of winding the second reinforcement layer in an opposite helical direction with respect to the windings of the first reinforcement layer.

17. The method of claim 10, wherein the step of helically winding the fabric cover comprises the step of winding the fabric cover in the same direction that the second reinforcement layer is wound.

18. The method of claim 10, wherein the step of helically winding the fabric cover comprises the step of winding the fabric cover in an opposite helical direction with respect to the windings of the second reinforcement layer.

19. An apparatus for forming a paint roller comprising:
a mandrel having a longitudinal axis;
a first feeder for continuously winding a core material around the longitudinal axis of the mandrel;
a second feeder for continuously winding a first reinforcing material around the core material;
a third feeder for continuously winding a second reinforcing material around the first reinforcing material;
a fourth feeder for continuously winding a fabric cover around the second reinforcement layer; and
a driving apparatus for advancing the core material, reinforcement layers and fabric cover along the mandrel.

20. The system of claim 19 comprising an adhesive applicator positioned to distribute adhesive onto the core material and the reinforcement layers.

21. A paint roller assembly comprising:
a core layer;
a plurality of reinforcement layers helically wound over the core layer;
a fabric cover helically wound over the plurality of reinforcement layers; and
adhesive for joining the core layer, the reinforcement layers, and the fabric cover together.

22. The paint roller assembly of claim 21, wherein at least one reinforcement layer is composed of a different material than another reinforcement layer.

23. The paint roller assembly of claim 21, wherein a density of at least one reinforcement layer is different than a density of another reinforcement layer.

24. The paint roller assembly of claim 21, wherein a thickness of at least one reinforcement layer is different than a thickness of another reinforcement layer.
